(19) United States
(12) Patent Application Publication
(10) Pub. No.: US 2016/0300099 A1
(43) Pub. Date: Oct. 13, 2016

(54) FACILITATING EFFICEINT FREE IN-PLANE ROTATION LANDMARK TRACKING OF IMAGES ON COMPUTING DEVICES

(71) Applicant: INTEL CORPORATION, Santa Clara, CA (US)

(72) Inventors: SHEN XIAOLU, Beijing (CN); Yangzhou Du, Beijing (CN); Minje Park, Seongnam (KR); Yeongjae Cheon, Seoul (KR); Olivier Duchenne, Seoul (KR); Tae-Hoon Kim, Seoul (KR)

(73) Assignee: INTEL CORPORATION, SANTA CLARA, CA (US)

(21) Appl. No.: 14/762,687

(22) PCT Filed: Sep. 25, 2014
(86) PCT No.: PCT/CN2014/087426

§ 371 Date: Jul. 22, 2015

(51) Int. Cl. G06K 9/00; G06T 7/00; G06F 3/01; G06T 7/20; G06T 1/00

(52) U.S. Cl. CPC G06K 9/00248; G06T 7/2033; G06T 1/0007; G06F 3/017; G06F 3/012; G06T 7/0022; G06T 2201/00; G06T 2207/10016

(57) ABSTRACT

A mechanism is described for facilitating efficient free in-plane rotation landmark tracking of images on computing devices according to one embodiment. A method of embodiments, as described herein, includes detecting a first frame having a first image and a second frame having a second image, where the second image is rotated to a position away from the first image. The method may further include assigning a first parameter line and a second parameter line to the second image based on landmark positions associated with the first and second images, detecting a rotation angle between the first parameter line and the second parameter line, and rotating the second image back and forth within a distance associated with the rotation angle to verify positions of the first and second images.

### FIELD

Embodiments described herein generally relate to computers. More particularly, embodiments relate to facilitating efficient free in-plane rotation landmark tracking of images on computing devices.

### BACKGROUND

With the increasing use of computing devices, particularly mobile computing devices, there is an increasing need to have a seamless and natural communication interface between computing devices and their corresponding users. Accordingly, a number of face tracking techniques have been developed to provide better facial tracking and positioning. However, these conventional techniques are severely limited in that they offer low quality or even jittery images being limited by the strength of their prediction models. Other conventional techniques try to solve these problems by employing a large number of prediction models which is highly inefficient in that the processing time is multiplied by the total number of these models, where the total model size is also multiplied which can result in time-consuming downloads of such applications on computing devices, such as mobile computing devices.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a mechanism for dynamic free rotation landmark detection according to one embodiment.

FIG. 2A illustrates a mechanism for dynamic free rotation landmark detection according to one embodiment.

FIG. 2B illustrates various facial images within their corresponding frames as facilitated by a mechanism for dynamic free rotation landmark detection of FIG. 2A according to one embodiment.

FIG. 3 illustrates a method for facilitating efficient free in-plane rotation landmark tracking of images on computing devices according to one embodiment.

FIG. 4 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a free rotation facial landmark tracking technique for facilitating accurate free rotation landmark positions (or simply referred to as “landmarks”) and dynamically estimating face poses and postures while overcoming any number and type of conventional challenges by enhancing the usability and quality of face tracking, and lowering the computation time, power usage, cache usage and other memory requirements, etc., because detecting facial landmarks can be extremely time and resource consuming in the processing pipeline of a computing device. It is contemplated that typical landmark points on human faces may include (but not limited to) eye corners, eye brows, mouth corners, nose tip, etc., and detection of such landmark points includes identifying the accurate position of these points after the appropriate region of the face is determined.

Embodiments provide for a free rotation facial landmark technique at a computing device for a robust in-plane rotation where a video input is taken and a number of facial landmark positions are output such that the technique is able to output accurate landmarks even as the user of the computing device rolls her head in a relatively large angle, where the rolling of the head refers to an in-plane rotation of the head. Further, in one embodiment, the facial landmark tracking technique may involve the following: (1) extract one or more image features from a current frame of the image; and (2) use a prediction model trained on a large training database to predict various landmark positions using the one or more image features.

In one embodiment, this output (e.g., face pose, landmark positions, etc.) of the facial landmark technique may be used for and drive any number and type of software applications relating (but not limited) to (1) animation; (2) expression analysis; (3) reconstruction (such two-dimensional (“2D”) or three-dimensional (“3D”) reconstructions, etc.); (4) registration; (5) identification, recognition, verification, and tracking (e.g., facial feature-based identification/recognition/verification/tracking); (6) face understanding (e.g., head or face gesture understanding); (7) digital photos; and (9) photo or image editing, such as for faces, eye expression interpretation, lie detection, lip reading, sign language interpretation, etc.

In one embodiment, localizing a facial landmark position may refer to a kernel process in many scenarios such as face recognition, expression analysis, photo enhancement, video driven animation, etc., and further, it may be used in mobile computing device's hardware and software services and by their provider companies, such as Google®, Apple®, Microsoft®, Samsung®, etc. This technique is also useful for mobile messaging and social and business media websites and their provider companies, such as Facebook®, Twitter®, LinkedIn®, etc. The technique enables the user to freely rotate the video capture device (e.g., mobile phone, tablet computer, web camera, etc.) while continuously providing stable and accurate landmark localization results without being impaired by any in-plane rotation angles caused by the free and frequent roll of the device.

Referring now to supervised descent method (“SDM”) and explicit shape regression (“ESR”), they provide use rotation-invariant image features, such as scale invariant feature transform (“SIFT”), and employ prediction models, such as support vector machine, trained on large database, to predict landmark positions. However, SDM and ESR are severely limited by the quality of image features and the strength of their prediction models. Further, when an in-plane angle increases, these conventional techniques often display jitter and inaccurate localization results, and even failure to detect and landmark. Another way to solve the problem is to use multiple models trained under different in-plane rotation angles; for example, such system may use any number of models, such as up to 8 models each covering 45 degree. However, in such systems, the overall model size is multiplied by the model number and given that for an input frame, the system uses all the models to localize the landmarks and then pick the best result, the processing time of such systems is inefficiently increased as it is multiplied by the total model number, and the model size is also multiplied which can result in time-consuming downloads of such applications on mobile computers, such as a smartphone.

Embodiments provide for facilitating the use of inter-frame continuous landmark position tracking in videos obtained from various source, such as a camera. For example, in one embodiment, in-plane rotation angle may be estimated from the left eye and right eye positions of a face image obtained from a previous frame and in a current frame, which is then used to rotate the image back by the same in-plane rotation angle. Thus, embodiments provide for performing the face landmark localization in a near up-right face. Further, in one embodiment, the technique's robustness and accuracy does not degrade with the increase in in-plane rotation angle, such as each time when a frame is rotated to have an up-right face for landmark localization. Embodiments allow for a 360-degree angle rotation and thus, this robustness against in-plane rotation is of great value, especially when the video is captured by a mobile handheld device, such as a smartphone, a tablet computer, etc. Accordingly, the use may roll his handheld device freely to frame a better shot, while the technique, in one embodiment, localizes stable and accurate landmarks without failure.

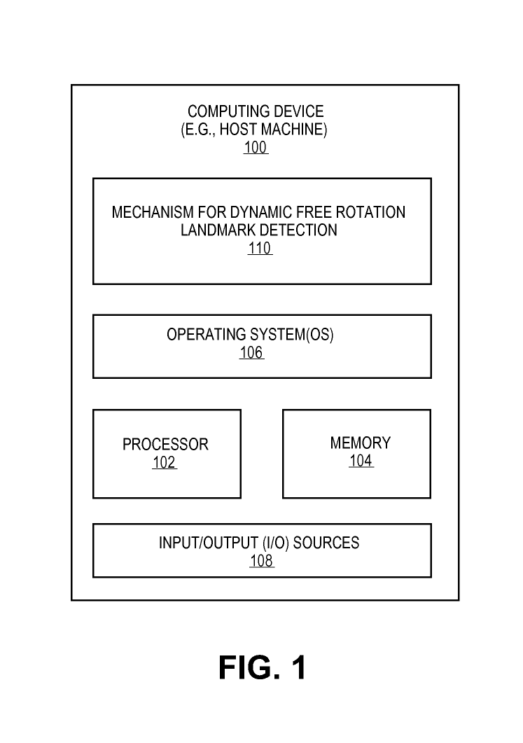

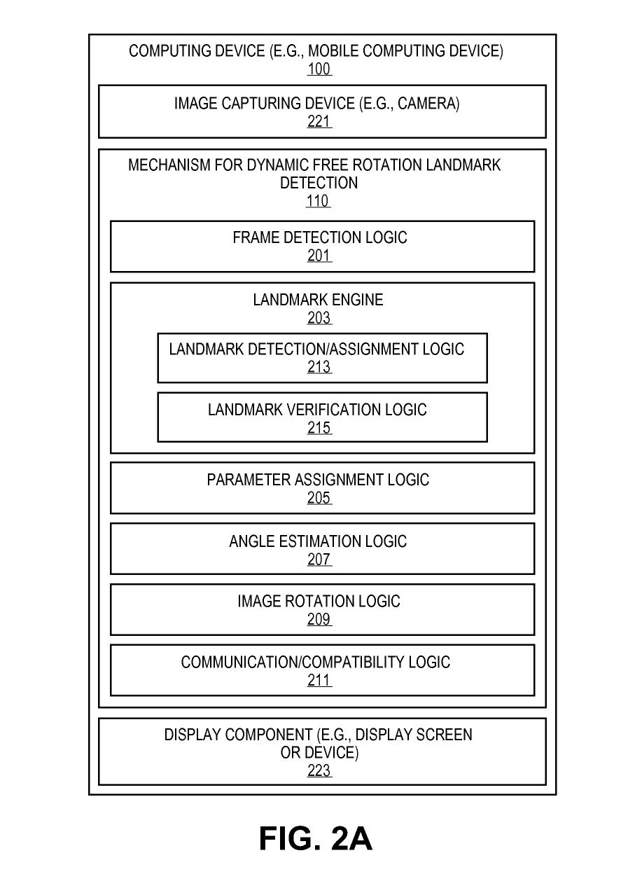

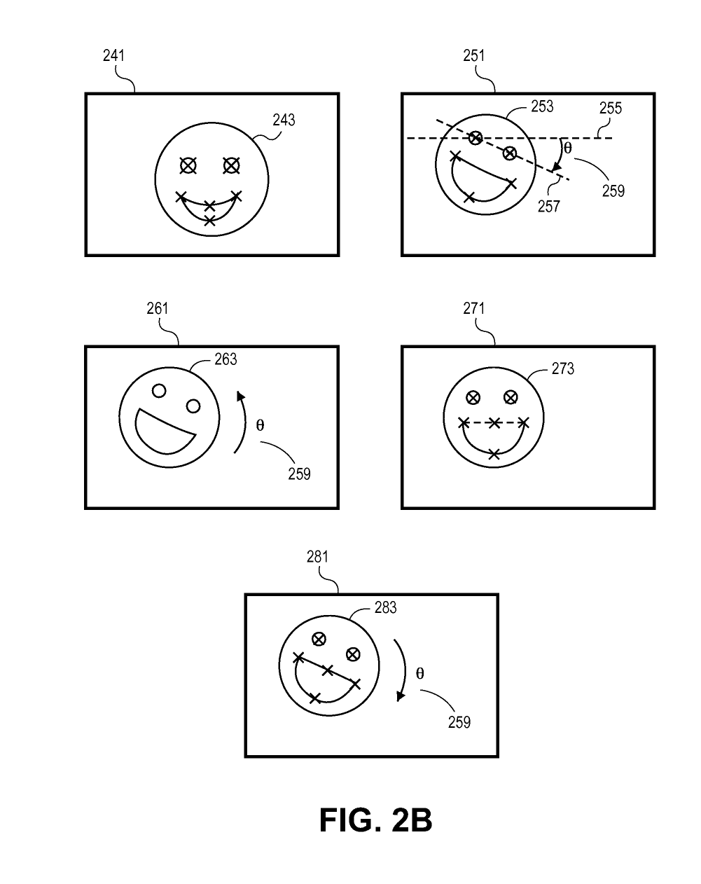

FIG. 1 illustrates a mechanism for dynamic free rotation landmark detection 110 according to one embodiment. Computing device 100 serves as a host machine for hosting a mechanism for dynamic rotation landmark detection 110 (“landmark mechanism”) 110 that includes any number and type of components, as illustrated in FIG. 2A, to efficiently perform dynamic and free in-plane rotation facial landmark detection and tracking as will be further described throughout this document.

Computing device 100 may include any number and type of communication devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones (e.g., iPhone® by Apple®, BlackBerry® by Research in Motion®, etc.), personal digital assistants (PDAs), tablet computers (e.g., iPad® by Apple®, Galaxy 3® by Samsung®, etc.), laptop computers (e.g., notebook, netbook, Ultrabook™ system, etc.), e-readers (e.g., Kindle® by Amazon®, Nook® by Barnes and Nobles®, etc.), media internet devices (“MIDs”), smart televisions, television platforms, wearable devices (e.g., watch, bracelet, smartcard, jewelry, clothing items, etc.), media players, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

FIG. 2A illustrates a mechanism for dynamic free rotation landmark detection 110 according to one embodiment. In one embodiment, a computing device, such as computing device 100 of FIG. 1 may serve as a host machine for hosting copying mechanism 110 that includes any number and type of components, such as: frame detection logic 201; landmark engine 203 includes landmark detection/assignment logic 213 and landmark verification logic 215; parameter assignment logic 205; angle estimation logic 207; image rotation logic 209; and communication/compatibility logic 211. Computing device 100 further includes image capturing device 221 (e.g., camera, video/photo capturing components, etc.) and display component 223 (e.g., display screen, display device, etc.).

In one embodiment, landmark mechanism 110 provides for a free rotation landmark tracking technique that deals with free in-plane rotation of images, such as facial images, which is particularly applicable in and helpful with small, handheld, mobile computing devices that are known for frequent rotations given that they are handled by hands, carried in pockets, placed on beds, etc. In contrast with conventional techniques, in one embodiment, landmark mechanism 110 merely necessitates a small training database since each frame is rotated back to near up-right position, the training database does not need to contain faces of all angles to track the face with free in-plane rotation. Further, landmark mechanism 110 merely employs a small model size and since this technique does not require or need to employ multiple prediction models, the total model size remains small, which is crucial for mobile applications. Further, the technique results in a relatively low workload and since the technique does not need to localize using multiple prediction models for multiple times for an input frame, the processing speed remains high, which is also crucial for mobile applications. Moreover, this technique can be used with various landmark localization systems which use image features as an input to enhance their robustness against in-plane rotation.

As an initial matter, it is contemplated that various processes and methods as described above and below are performed in the background unbeknownst to the user of computing device 100. For example, in one embodiment, the user may start out with a first frame, such as frame 241 of FIG. 2B, having, for example, a self-facial image in an up-right position, such as facial image 243 (here, for example, the user's face is shown as smiling). Then, upon causing a movement or rotation of the user's face and/or computing device 100, the facial image rotates and changes in a second frame, such as frame 251 of FIG. 2B, having a tilted facial image, such as facial image 253 (here, for example, the user's face is shown as laughing and tilted to one side) of frame 251. Thus, it is contemplated that the user may only see the aforementioned images 243, 253 without any interruption or landmark positions or parameter lines, etc., while other processes as facilitated by landmark mechanism 110 are performed in the background without the user's knowledge.

Further, in one embodiment, images 243, 253 of FIG. 2B may be detected in or obtained from a video that is captured using one or more image capturing device, such as image capturing device 221, and then displayed via one or more display devices/screens, such as display component 223, of computing device 100.

In one embodiment, frame detection logic 201 is triggered upon detecting the first frame, such as frame 241 of FIG. 2B, in a video being captured by an image capturing device, such as image capturing device 221. For example, frame detection logic 201 may detect and accept a facial image (or simply “image”) of a user captured through a camera, such as image capturing device 221, as an input and forward this information on to landmark engine 203 for output of landmark positions. Upon having frame detection logic 201 detect the facial image in the first frame, landmark engine 203 may then detect and output any number of landmark positions on the facial image of the first frame using any number and type of landmark position detection processes. For example, in one embodiment, these landmark positions may be detected or assigned by landmark detection/assignment logic 213 at any number and type of points on the face in the facial image, such as the two eyes, the two corners of the lips, and the middle points of the upper and lower lips, etc. Since at the beginning, the user typically poses the head up-right, such as in frame 241 of FIG. 2B, the first frame often has a small in-plane rotation angle and thus, landmark engine 203 is able to run successfully and accurately. Further, in one embodiment, landmark verification logic 215 may be used to verify various landmark positions assigned to the images at various points during and after the back-and-forth rotations of images as illustrated with in FIG. 2B.

At some point, the user may move (or tilt or rotate) his/her face or computing device 100 itself which generates another tilted facial image, such as image 253 of FIG. 2B, and is portrayed in a second frame, such as frame 251 of FIG. 2B, where the movement or rotation is detected by image rotation logic 209. Upon detection of the rotation of the facial image by image rotation logic 209, parameter assignment logic 205 is triggered which may then be used to assign parameters or parameter lines to any number of detected and outputted landmark points for further processing. For example, as illustrated with reference to frame 251 of FIG. 2B, an inflexible or unmovable parameter line that is regarded as a first parameter line may be assigned to the facial image such that the first parameter line is grounded in one landmark point of one eye and runs horizontally straight and remains in its angle even if the face is rotated in response to the user moving the head. Similarly, for example, a second parameter line that is flexible and movable may be assigned to connect the two landmark points at the two eyes such that the second parameter line may run across the two landmark points of the two eyes and rotate in the equal amount as the two eyes are rotated. In one embodiment, one or more parameter lines may be assigned to the facial image when the first frame is received with the facial image being up-right or, in another embodiment, when the second frame is generated in response to the facial image being tilted due to the movement of the face and/or computing device 100.

Once the parameter lines are assigned by parameter assignment logic 205, angle estimation logic 207 may be ready to detect any movement between the two parameter lines, where the movement may correspond to the rotation of the face. For example, as aforementioned, when the face is rotated, such as the user moving the face and/or computing device 100, its frame, such as the second frame, may be detected by frame detection logic 205 while its rotation may be detected by image rotation logic 209. Having already detected/assigned the landmark points by landmark detection/assignment logic 213 and assigned the parameter lines by parameter assignment logic 205, respectively, any gap that is generated due to the movement between the parameter lines corresponding to the rotation of the face may be estimated by angle estimation logic 207. As illustrated with reference to frame 251 of FIG. 2B, a gap that is generated between the first and second parameter lines may be detected by angle estimation logic 207 and computed as a rotation angle (also referenced as “theta” or simply “θ”). It is contemplated that in one embodiment the first and second parameter lines may not be actually drawn on any of the images and that they are merely illustrated as reference points and that any number and type of reference points may be used or employed by the in-plane rotation angle formula to successfully calculate one or more in-plane rotation angles, as desired or necessitated. For example, the left eye center position of the facial image may be denoted by (lx, ly), and right eye center position of the facial image may be denoted by (rx, ry) and accordingly, the in-plane rotation angle, θ, may then be calculated by angle estimation logic 207 via, for example, the following in-plane rotation angle formula:

$$θ = a tan ( \frac{ry - iy}{rx - ix} )$$

In one embodiment, upon detection of the rotation angle, θ, the facial image may then be rotated back, such as in the opposite direction, by the same amount as the rotation angle, such as by −θ, by image rotation logic 209 to obtain a normalized image in another background frame, such as frame 271 of FIGS. 2B. It is contemplated that since a camera frame rate (such as 30 frames-per-second (fps) for most mobile phones) is relatively higher than a typical human movement, it is safely determined that the in-plane rotation angle between the facial image of the original frame, such as the first frame, and the rotated-back normalized image of the third frame may be a relatively small amount (such as a negligible +/−difference of a fraction of a degree) and accordingly, the normalized image in the third frame may contain a near up-right face being approximately the same as the original positioning of the face in the first frame. For example, the original facial image in the first frame (such as frame 241 of FIG. 2B) is up-right at 0° and it is then rotated to be at 30° in the second frame (such as frames 251 of FIG. 2B) which is then rotated back to be the normalized facial image at near up-right at +/−1°, such as in frame 271 of FIG. 2B. It is contemplated that this example is merely provided for brevity and ease of understanding and that embodiments are not limited to any particular angle or degrees of angle. Similarly, it is contemplated that although a human face is used and referenced throughout the document, it is merely used as an example and for the sake of brevity and ease of understanding and that embodiments are in no way limited only to human faces and that embodiments may be applied to any other parts of human body as well as to animals, plants, and other non-living objects, such as pictures, paintings, animation, rocks, books, etc.

In one embodiment, landmark engine 203 accurately detects landmark positions on the normalized image of the third frame and since the face is already rotated back to the near up-right position, regardless of how large or small the original rotation angle, θ, may be, the newly detected landmark positions may still be detected successfully and accurately. Stated differently, in one embodiment, the ability of parameter assignment logic 205 to accurately assign parameters (e.g., parameter lines), angle estimation logic 207 to accurately compute the rotation angle, and image rotation logic 209 to rotate the image back to its near up-right position allows for the user to have the flexibility to freely rotate computing device 100 or move his/her person whose image is being captured by image capturing device 221 of computing device 100 as much as desired or necessitated, such as creating the rotation angle as big or small, without losing the capability to seamlessly capture the image and the ability to accurately maintain the facial landmark positions on the captured image. This allows for a seamless and dynamic movement of images being portrayed on a relatively movable or portable computing devices, such as computing device 100 having any number and type of mobile computing devices (e.g., smartphones, tablet computers, laptop computers, etc.), without sacrificing the quality of those image or losing their landmark positions.

Once the landmark positions have been detected/assigned by landmark detection/assignment logic 213 and then verified by landmark verification logic 215 on the normalized image, the facial image may then be rotated back, via image rotation logic 209, into another frame, such as frame 281 of FIG. 2B, to the way the user may have intended, such as back to the position of the second frame which is the amount of the rotation angle, θ, from the original up-right position of the first frame. As aforementioned, the aforementioned embodiments may be stored and used for and applied in any number of software applications using image landmark positions, such as for animation, identification/verification, registration, digital photos, videos, etc.

Communication/compatibility logic 211 may be used to facilitate dynamic communication and compatibility between computing device 100 and any number and type of other computing devices (such as mobile computing device, desktop computer, server computing device, etc.), processing devices (such as central processing unit (CPU), graphics processing unit (GPU), etc.), image capturing devices (e.g., image capturing device 221, such as a camera), display elements (e.g., display component 223, such as a display device, display screen, etc.), user/context-awareness components and/or identification/verification sensors/devices (such as biometric sensor/detector, scanner, etc.), memory or storage devices, databases and/or data sources (such as data storage device, hard drive, solid-state drive, hard disk, memory card or device, memory circuit, etc.), networks (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), wireless or wired communications and relevant protocols (e.g., Wi-Fi®, WiMAX, Ethernet, etc.), connectivity and location management techniques, software applications/websites, (e.g., social and/or business networking websites, such as Facebook®, LinkedIn®, Google+®, Twitter®, etc., business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “point”, “tool”, and the like, may be referenced interchangeably and include, by way of example, software, hardware, and/or any combination of software and hardware, such as firmware. Further, any use of a particular brand, word, term, phrase, name, and/or acronym, such as “landmarks”, “landmark positions”, “face” or “facial”, “SDM”, “ESR”, “SIFT”, “image”, “theta” or “θ”, “rotation”, “movement”, “normalization”, “up-right” or “near up-right”, “GPU”, “CPU”, “1D”, “2D”, “3D”, “aligned”, “unaligned”, etc., should not be read to limit embodiments to software or devices that carry that label in products or in literature external to this document.

It is contemplated that any number and type of components may be added to and/or removed from landmark mechanism 110 to facilitate various embodiments including adding, removing, and/or enhancing certain features. For brevity, clarity, and ease of understanding of landmark mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 2B illustrates various facial images within their corresponding frames as facilitated by mechanism for dynamic free rotation landmark detection 110 of FIG. 2A according to one embodiment. For brevity and clarity, many of the details provided above with reference to FIG. 2A will not be discussed or repeated here. In one embodiment, frame 241 having facial image 243 of an up-right position is detected and received as an input from a video captured by an image capturing device of a computing device, such as image capturing device 221 of computing device 100 of FIG. 2A. Then, frame 251 is detected and received when previous facial image 243 is rotated into facial image 253 due to a movement by the user of his/her face and/or the movement of the computing device, such as computing device 100 of FIG. 2A. As aforementioned, in one embodiment, images 243, 253 may be detected in or obtained from a video that is captured using one or more image capturing devices, such as image capturing device 221, and then displayed via one or more display devices/screens, such as display component 223, of computing device 100 of FIG. 2A.

As previously discussed with reference to FIG. 2A, a number and type of landmark positions are detected on facial image 253 and one or more parameters, such as first and second parameter lines 255, 257, are assigned to facial image 253. As illustrated here with respect to frame 251, an inflexible or unmovable parameter line, such as first parameter line 255, is assigned to be anchored at one of the landmark positions, such as one of the eyes, and remains and runs horizontally through rotated facial image 253. Similarly, as illustrated, another flexible and movable parameter line, such as second parameter line 257, is assigned to run through and stay true to two landmark positions, such as representing the two eyes, and rotate the same distance as the twos eyes corresponding to the rotation of the entire facial image 253. In one embodiment, this rotation of facial image 253 creates a gap representing an angle between first parameter line 255 and second parameter line 257 which is regarded as rotation angle 259, denoted by θ.

As previously described with reference to FIG. 2A, rotation angle 259 (e.g., 30°) is estimated or computed for facial image 253 of background frame 251 such that is may then be stored in database and used for a subsequent facial image, such as facial image 263, of frame 261 which is the same as the second frame. In one embodiment, facial image 263 of frame 261 may be rotated back the same distance as rotation angle 259 (e.g., 30°) to be at near up-right position to produce a normalized image, such as facial image 273, of frame 271 where the same facial landmark positions may also be assigned to facial image 273. These landmark positions and rotation angle 259 remain stored for future transactions while, using the landmark positions and the already estimated rotation angle 259, facial image 273 is rotated back the same distance as rotation angle 259 to facilitate facial image 283 of frame 281 which is similar to facial image 253 which the user may view via a display screen of a computing device.

It is to be noted that the user may only see the clean images that include an up-right image, such as the original smiling image 243 of first frame 241, and then the subsequent rotated image, such as the rotated laughing image 253 of second frame 251, and that the aforementioned processes of detecting, estimating, rotating, etc., take place in the background without interfering with the user's viewing experience. It is contemplated that in one embodiment the first and second parameter lines 255, 257 may not be actually drawn on the image, such as any of the illustrated images 243, 253, 263, 273, 283, and that they are merely illustrated here as reference points and it is further contemplated that in one embodiment, the in-plane rotation angle formula shown below and in reference to FIG. 2A may use and employ number and variety of reference points to calculate an in-plane rotation angle, the in-plane rotation angle formula is as follows:

$$θ = a tan ( \frac{ry - iy}{rx - ix} )$$

where (lx, ly) denotes the left eye center position of the facial image, (rx, ry) denotes the right eye center position of the facial image, and θ represents the in-plane rotation angle.

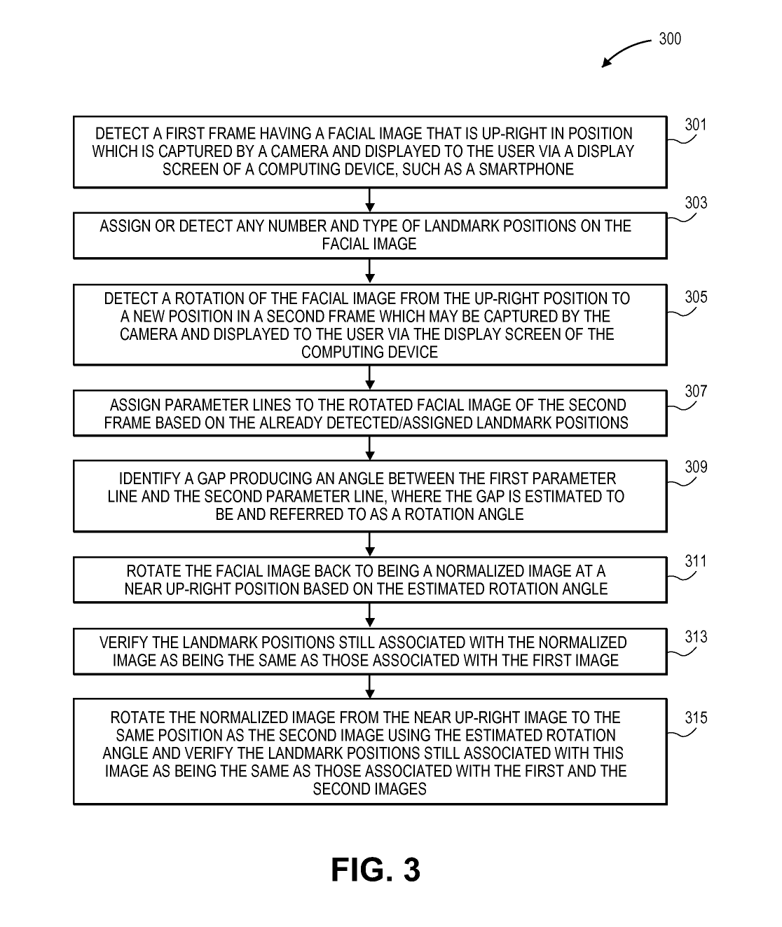

FIG. 3 illustrates a method 300 for facilitating efficient free in-plane rotation landmark tracking of images on computing devices according to one embodiment. Method 300 may be performed by processing logic that may comprise hardware (e.g., circuitry, dedicated logic, programmable logic, etc.), software (such as instructions run on a processing device), or a combination thereof. In one embodiment, method 300 may be performed by landmark mechanism 110 of FIG. 1. The processes of method 300 are illustrated in linear sequences for brevity and clarity in presentation; however, it is contemplated that any number of them can be performed in parallel, asynchronously, or in different orders. For brevity, many of the details discussed with reference to FIGS. 1, 2A and 2B are not discussed or repeated hereafter.

Method 300 begins at block 301 with detecting a first frame having a facial image that is up-right in position which is captured by a camera and displayed to the user via a display screen of a computing device, such as a smartphone. At block 303, any number and type of landmark positions are detected on the facial image. At block 305, a rotation of the facial image from the up-right position to a new position is detected in a second frame which may be captured by the camera and displayed to the user via the display screen of the computing device, such as a smartphone. At block 307, using and applying the landmark positions of the first frame, a number of parameters, such as a couple of parameter lines, are assigned to the rotated facial image of the second frame. In one embodiment, the couple of parameter lines may include a fixed first parameter line and a movable second parameter line. As aforementioned, it is contemplated that in one embodiment the first and second parameter lines/points may not be actually drawn on the image and that they may simply be regarded as reference lines where an in-plane rotation angle may be calculated by using and applying the in-plane rotation angle formula as illustrated with reference to FIGS. 2A and 2B.

In one embodiment, at block 309, a gap producing angle is detected between the first parameter line and the second parameter line, where the gap is estimated to be and referred to as a rotation angle. At block 311, using and applying the rotation angle, the facial image is rotated back to being a normalized image at a near up-right position. At block 313, a number of landmark positions are detected and verified as being the same as those detected earlier in the first frame. At block 315, the near up-right image is rotated back by the same distance as the rotation angle such that is resembles the initially rotated image of the second frame which is expected to be seen by the user. In one embodiment, the landmark points and parameter lines are detected, verified, and stored so that they may be applied to future movements and occurrences of images, such as the ones described earlier, without sacrificing the quality of images and/or having employed large prediction models.

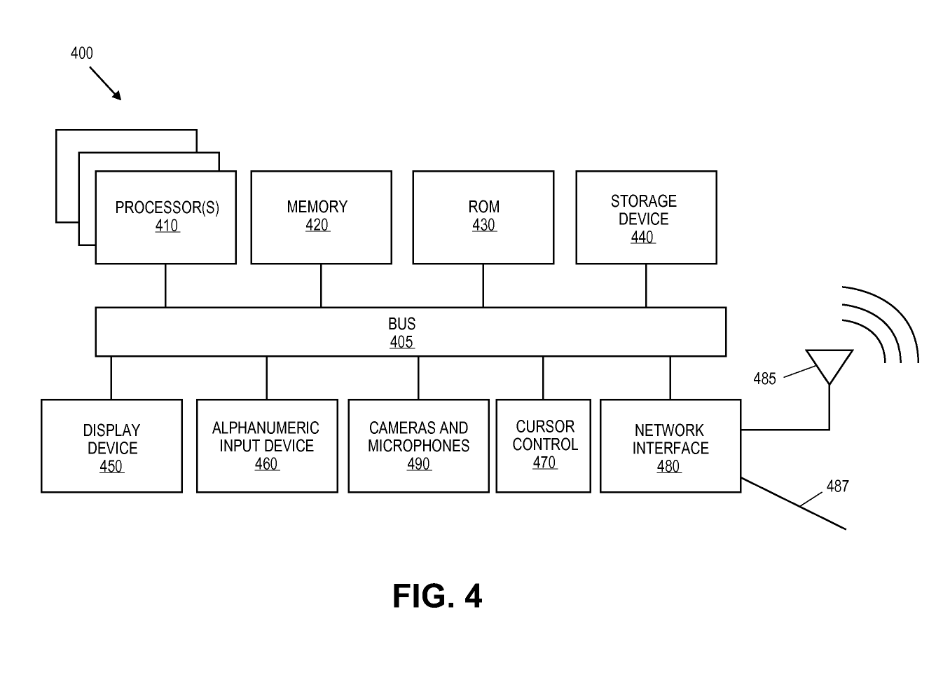

FIG. 4 illustrates an embodiment of a computing system 400. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components. Computing device 400 may be the same as or similar to or include computing device 100 of FIG. 1.

Computing system 400 includes bus 405 (or, for example, a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate free rotation landmark tracking of images on computing devices, comprising: frame detection logic to detect a first frame having a first image and a second frame having a second image, wherein the first image associated with an initial location is rotated into the second image associated with a current location; parameter assignment logic to assign a first parameter line and a second parameter line to the second image based on landmark positions associated with the first and second images; and angle estimation logic to detect a rotation angle between the first parameter line and the second parameter line; and image rotation logic to rotate the second image back and forth within a distance associated with the rotation angle to verify positions of the first and second images.

Example 2 includes the subject matter of Example 1, further comprising: landmark detection/assignment logic of landmark engine to detect the landmark positions on the first image and convey the landmark positions of the first image to the second image, wherein the landmark positions are associated with a plurality of points on the first and second images, wherein the first and second images include first and second facial images, and wherein the plurality of points include one or more of corner of eyes, corners or middle of lips, tip of a nose, and middle of earlobes.

Example 3 includes the subject matter of Example 1 or 2, wherein the landmark detection/assignment logic is further to assign the landmark positions to the first image, and wherein the landmark engine further includes landmark verification logic to verify the landmark positions conveyed to the second image after the first image at the initial location is rotated into the second image at the current location and rotated back to a near-first image at a near-initial location based on the rotation angle.

Example 4 includes the subject matter of Example 1, further comprising: an image capturing device to capture the first and second images of a user of the apparatus, wherein the image capturing device includes a camera; communication/compatibility logic to facilitate communication of the first and second images from the image capturing device to a display device; and the display device to display the first image at a first point in time, and the second image at a second point in time.

Example 5 includes the subject matter of Example 1 or 4, wherein the first image and the second image are detected from the first frame and the second frame, respectively, wherein the first and second frames are detected from a video stream of a video captured via the image capturing device.

Example 6 includes the subject matter of Example 1, wherein the first parameter line comprises an immovable parameter line running in a first direction across the second image, wherein the first parameter line being anchored in one of the landmark positions associated with the first and second images.

Example 7 includes the subject matter of Example 6, wherein the first parameter line remains running in the first direction when the first image rotates to the second image, wherein the first direction includes at least one of a horizontal direction, a vertical direction, a diagonal direction.

Example 8 includes the subject matter of Example 1, wherein the second parameter line comprises a movable parameter line running in a second direction across the second image, wherein the second parameter line being anchored in at least two of the landmark positions associated with the first and second images, wherein the second parameter line remains anchored in and moves corresponding to the at least two of the landmark positions as the first image rotates to the second image.

Example 9 includes the subject matter of Example claim 1, wherein the rotation angle represents a rotational gap between the first parameter line and the second parameter line, wherein the rotational gap is generated when the first image associated with the initial location turns in-plane into the second image associated with the current location, wherein the initial location includes an up-right position, the current location incudes a tilted position, and the near-initial location includes a near up-right position.

Example 10 includes the subject matter of Example claim 1, wherein the first image turns into the second image in response to a user movement associated with the user or an apparatus movement associated with the apparatus as facilitated by the user.

Some embodiments pertain to Example 11 that includes a method for facilitating free rotation landmark tracking of images on computing devices, comprising: detecting a first frame having a first image and a second frame having a second image, wherein the first image associated with an initial location is rotated into the second image associated with a current location; assigning a first parameter line and a second parameter line to the second image based on landmark positions associated with the first and second images; detecting a rotation angle between the first parameter line and the second parameter line; and rotating the second image back and forth within a distance associated with the rotation angle to verify positions of the first and second images.

Example 12 includes the subject matter of Example 11, further comprising: detecting the landmark positions on the first image and conveying the landmark positions of the first image to the second image, wherein the landmark positions are associated with a plurality of points on the first and second images, wherein the first and second images include first and second facial images, and wherein the plurality of points include one or more of corner of eyes, corners or middle of lips, tip of a nose, and middle of earlobes.

Example 13 includes the subject matter of Example 11 or 12, wherein the landmark positions are assigned to the first image, and wherein the method further comprises: verifying the landmark positions conveyed to the second image after the first image at the initial location is rotated into the second image at the current location and rotated back to a near-first image at a near-initial location based on the rotation angle.

Example 14 includes the subject matter of Example 11, further comprising: capturing, via an image capturing device, the first and second images of a user, wherein the image capturing device includes a camera; facilitating communication of the first and second images from the image capturing device to a display device; and displaying, via the display device, the first image at a first point in time, and the second image at a second point in time.

Example 15 includes the subject matter of Example 11 or 14, wherein the first image and the second image are detected from the first frame and the second frame, respectively, wherein the first and second frames are detected from a video stream of a video captured via the image capturing device.

Example 16 includes the subject matter of Example 11, wherein the first parameter line comprises an immovable parameter line running in a first direction across the second image, wherein the first parameter line being anchored in one of the landmark positions associated with the first and second images.

Example 17 includes the subject matter of Example 16, wherein the first parameter line remains running in the first direction when the first image rotates to the second image, wherein the first direction includes at least one of a horizontal direction, a vertical direction, a diagonal direction.

Example 18 includes the subject matter of Example 11, wherein the second parameter line comprises a movable parameter line running in a second direction across the second image, wherein the second parameter line being anchored in at least two of the landmark positions associated with the first and second images, wherein the second parameter line remains anchored in and moves corresponding to the at least two of the landmark positions as the first image rotates to the second image.

Example 19 includes the subject matter of Example 11, wherein the rotation angle represents a rotational gap between the first parameter line and the second parameter line, wherein the rotational gap is generated when the first image associated with the initial location turns in-plane into the second image associated with the current location, wherein the initial location includes an up-right position, the current location incudes a tilted position, and the near-initial location includes a near up-right position.

Example 20 includes the subject matter of Example 11, wherein the first image turns into the second image in response to a user movement associated with the user or an apparatus movement associated with the apparatus as facilitated by the user.

Example 21 includes at least one machine-readable medium comprising a plurality of instructions, when executed on a computing device, to implement or perform a method or realize an apparatus as claimed in any preceding claims.

Example 22 includes at least one non-transitory or tangible machine-readable medium comprising a plurality of instructions, when executed on a computing device, to implement or perform a method or realize an apparatus as claimed in any preceding claims.

Example 23 includes a system comprising a mechanism to implement or perform a method or realize an apparatus as claimed in any preceding claims.

Example 24 includes an apparatus comprising means to perform a method as claimed in any preceding claims.

Example 25 includes a computing device arranged to implement or perform a method or realize an apparatus as claimed in any preceding claims.

Example 26 includes a communications device arranged to implement or perform a method or realize an apparatus as claimed in any preceding claims.

Some embodiments pertain to Example 27 includes a system comprising a storage device having instructions, and a processor to execute the instructions to facilitate a mechanism to perform one or more operations comprising: detecting a first frame having a first image and a second frame having a second image, wherein the first image associated with an initial location is rotated into the second image associated with a current location; assigning a first parameter line and a second parameter line to the second image based on landmark positions associated with the first and second images; detecting a rotation angle between the first parameter line and the second parameter line; and rotating the second image back and forth within a distance associated with the rotation angle to verify positions of the first and second images.

Example 28 includes the subject matter of Example 27, wherein the one or more operations further comprise: detecting the landmark positions on the first image and conveying the landmark positions of the first image to the second image, wherein the landmark positions are associated with a plurality of points on the first and second images, wherein the first and second images include first and second facial images, and wherein the plurality of points include one or more of corner of eyes, corners or middle of lips, tip of a nose, and middle of earlobes.

Example 29 includes the subject matter of Example 27 or 28, wherein the landmark positions are assigned to the first image, and wherein the method further comprises: verifying the landmark positions conveyed to the second image after the first image at the initial location is rotated into the second image at the current location and rotated back to a near-first image at a near-initial location based on the rotation angle.

Example 30 includes the subject matter of Example 27, wherein the one or more operations further comprise: capturing, via an image capturing device, the first and second images of a user, wherein the image capturing device includes a camera; facilitating communication of the first and second images from the image capturing device to a display device; and displaying, via the display device, the first image at a first point in time, and the second image at a second point in time.

Example 31 includes the subject matter of Example 27 or 30, wherein the first image and the second image are detected from the first frame and the second frame, respectively, wherein the first and second frames are detected from a video stream of a video captured via the image capturing device.

Example 32 includes the subject matter of Example 27, wherein the first parameter line comprises an immovable parameter line running in a first direction across the second image, wherein the first parameter line being anchored in one of the landmark positions associated with the first and second images.

Example 33 includes the subject matter of Example 32, wherein the first parameter line remains running in the first direction when the first image rotates to the second image, wherein the first direction includes at least one of a horizontal direction, a vertical direction, a diagonal direction.

Example 34 includes the subject matter of Example 27, wherein the second parameter line comprises a movable parameter line running in a second direction across the second image, wherein the second parameter line being anchored in at least two of the landmark positions associated with the first and second images, wherein the second parameter line remains anchored in and moves corresponding to the at least two of the landmark positions as the first image rotates to the second image.

Example 35 includes the subject matter of Example 27, wherein the rotation angle represents a rotational gap between the first parameter line and the second parameter line, wherein the rotational gap is generated when the first image associated with the initial location turns in-plane into the second image associated with the current location, wherein the initial location includes an up-right position, the current location incudes a tilted position, and the near-initial location includes a near up-right position.

Example 36 includes the subject matter of Example 27, wherein the first image turns into the second image in response to a user movement associated with the user or an apparatus movement associated with the apparatus as facilitated by the user.

Some embodiments pertain to Example 37 includes an apparatus comprising: means for detecting a first frame having a first image and a second frame having a second image, wherein the first image associated with an initial location is rotated into the second image associated with a current location; means for assigning a first parameter line and a second parameter line to the second image based on landmark positions associated with the first and second images; means for detecting a rotation angle between the first parameter line and the second parameter line; and means for rotating the second image back and forth within a distance associated with the rotation angle to verify positions of the first and second images.

Example 38 includes the subject matter of Example 37, further comprising: means for detecting the landmark positions on the first image and conveying the landmark positions of the first image to the second image, wherein the landmark positions are associated with a plurality of points on the first and second images, wherein the first and second images include first and second facial images, and wherein the plurality of points include one or more of corner of eyes, corners or middle of lips, tip of a nose, and middle of earlobes.

Example 39 includes the subject matter of Example 37 or 38, wherein the landmark positions are assigned to the first image, and wherein the method further comprises: verifying the landmark positions conveyed to the second image after the first image at the initial location is rotated into the second image at the current location and rotated back to a near-first image at a near-initial location based on the rotation angle.

Example 40 includes the subject matter of Example 37, further comprising: means for capturing, via an image capturing device, the first and second images of a user, wherein the image capturing device includes a camera; means for facilitating communication of the first and second images from the image capturing device to a display device; and means for displaying, via the display device, the first image at a first point in time, and the second image at a second point in time.

Example 41 includes the subject matter of Example 37 or 40, wherein the first image and the second image are detected from the first frame and the second frame, respectively, wherein the first and second frames are detected from a video stream of a video captured via the image capturing device.

Example 42 includes the subject matter of Example 37, wherein the first parameter line comprises an immovable parameter line running in a first direction across the second image, wherein the first parameter line being anchored in one of the landmark positions associated with the first and second images.

Example 43 includes the subject matter of Example 42, wherein the first parameter line remains running in the first direction when the first image rotates to the second image, wherein the first direction includes at least one of a horizontal direction, a vertical direction, a diagonal direction.

Example 44 includes the subject matter of Example 37, wherein the second parameter line comprises a movable parameter line running in a second direction across the second image, wherein the second parameter line being anchored in at least two of the landmark positions associated with the first and second images, wherein the second parameter line remains anchored in and moves corresponding to the at least two of the landmark positions as the first image rotates to the second image.

Example 45 includes the subject matter of Example 37, wherein the rotation angle represents a rotational gap between the first parameter line and the second parameter line, wherein the rotational gap is generated when the first image associated with the initial location turns in-plane into the second image associated with the current location, wherein the initial location includes an up-right position, the current location incudes a tilted position, and the near-initial location includes a near up-right position.

Example 46 includes the subject matter of Example 37, wherein the first image turns into the second image in response to a user movement associated with the user or an apparatus movement associated with the apparatus as facilitated by the user.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1-25. (canceled)

26. An apparatus comprising:
frame detection logic to detect a first frame having a first image and a second frame having a second image, wherein the first image associated with an initial location is rotated into the second image associated with a current location;
parameter assignment logic to assign a first parameter line and a second parameter line to the second image based on landmark positions associated with the first and second images;
angle estimation logic to detect a rotation angle between the first parameter line and the second parameter line; and
image rotation logic to rotate the second image back and forth within a distance associated with the rotation angle to verify positions of the first and second images.

27. The apparatus of claim 26, further comprising:
landmark detection/assignment logic of landmark engine to detect the landmark positions on the first image and convey the landmark positions of the first image to the second image, wherein the landmark positions are associated with a plurality of points on the first and second images, wherein the first and second images include first and second facial images, and wherein the plurality of points include one or more of corner of eyes, corners or middle of lips, tip of a nose, and middle of earlobes,
wherein the landmark detection/assignment logic is further to assign the landmark positions to the first image, and wherein the landmark engine further includes landmark verification logic to verify the landmark positions conveyed to the second image after the first image at the initial location is rotated into the second image at the current location and rotated back to a near-first image at a near-initial location based on the rotation angle.

28. The apparatus of claim 26, further comprising:
an image capturing device to capture the first and second images of a user of the apparatus, wherein the image capturing device includes a camera;
communication/compatibility logic to facilitate communication of the first and second images from the image capturing device to a display device; and
the display device to display the first image at a first point in time, and the second image at a second point in time.

29. The apparatus of claim 28, wherein the first image and the second image are detected from the first frame and the second frame, respectively, wherein the first and second frames are detected from a video stream of a video captured via the image capturing device.

30. The apparatus of claim 26, wherein the first parameter line comprises an immovable parameter line running in a first direction across the second image, wherein the first parameter line being anchored in one of the landmark positions associated with the first and second images, wherein the first parameter line remains running in the first direction when the first image rotates to the second image, wherein the first direction includes at least one of a horizontal direction, a vertical direction, a diagonal direction.

31. The apparatus of claim 26, wherein the second parameter line comprises a movable parameter line running in a second direction across the second image, wherein the second parameter line being anchored in at least two of the landmark positions associated with the first and second images, wherein the second parameter line remains anchored in and moves corresponding to the at least two of the landmark positions as the first image rotates to the second image.

32. The apparatus of claim 26, wherein the rotation angle represents a rotational gap between the first parameter line and the second parameter line, wherein the rotational gap is generated when the first image associated with the initial location turns in-plane into the second image associated with the current location, wherein the initial location includes an up-right position, the current location incudes a tilted position, and the near-initial location includes a near up-right position.

33. The apparatus of claim 26, wherein the first image turns into the second image in response to a user movement associated with the user or an apparatus movement associated with the apparatus as facilitated by the user.

34. A method comprising:
detecting a first frame having a first image and a second frame having a second image, wherein the first image associated with an initial location is rotated into the second image associated with a current location;
assigning a first parameter line and a second parameter line to the second image based on landmark positions associated with the first and second images;
detecting a rotation angle between the first parameter line and the second parameter line; and
rotating the second image back and forth within a distance associated with the rotation angle to verify positions of the first and second images.

35. The method of claim 34, further comprising:
detecting the landmark positions on the first image and conveying the landmark positions of the first image to the second image, wherein the landmark positions are associated with a plurality of points on the first and second images, wherein the first and second images include first and second facial images, and wherein the plurality of points include one or more of corner of eyes, corners or middle of lips, tip of a nose, and middle of earlobes, wherein the landmark positions are assigned to the first image; and
verifying the landmark positions conveyed to the second image after the first image at the initial location is rotated into the second image at the current location and rotated back to a near-first image at a near-initial location based on the rotation angle.

36. The method of claim 34, further comprising:
capturing, via an image capturing device, the first and second images of a user, wherein the image capturing device includes a camera;
facilitating communication of the first and second images from the image capturing device to a display device; and
displaying, via the display device, the first image at a first point in time, and the second image at a second point in time.

37. The method of claim 36, wherein the first image and the second image are detected from the first frame and the second frame, respectively, wherein the first and second frames are detected from a video stream of a video captured via the image capturing device.

38. The method of claim 36, wherein the first parameter line comprises an immovable parameter line running in a first direction across the second image, wherein the first parameter line being anchored in one of the landmark positions associated with the first and second images, wherein the first parameter line remains running in the first direction when the first image rotates to the second image, wherein the first direction includes at least one of a horizontal direction, a vertical direction, a diagonal direction.

39. The method of claim 34, wherein the second parameter line comprises a movable parameter line running in a second direction across the second image, wherein the second parameter line being anchored in at least two of the landmark positions associated with the first and second images, wherein the second parameter line remains anchored in and moves corresponding to the at least two of the landmark positions as the first image rotates to the second image.

40. The method of claim 34, wherein the rotation angle represents a rotational gap between the first parameter line and the second parameter line, wherein the rotational gap is generated when the first image associated with the initial location turns in-plane into the second image associated with the current location, wherein the initial location includes an up-right position, the current location incudes a tilted position, and the near-initial location includes a near up-right position.

41. The method of claim 34, wherein the first image turns into the second image in response to a user movement associated with the user or an apparatus movement associated with the apparatus as facilitated by the user.

42. At least one machine-readable medium comprising a plurality of instructions, when executed on a computing device, to cause the computing device to perform one or more operations comprising:
detecting a first frame having a first image and a second frame having a second image, wherein the first image associated with an initial location is rotated into the second image associated with a current location;
assigning a first parameter line and a second parameter line to the second image based on landmark positions associated with the first and second images;
detecting a rotation angle between the first parameter line and the second parameter line; and
rotating the second image back and forth within a distance associated with the rotation angle to verify positions of the first and second images.

43. The machine-readable medium of claim 42, wherein the one or more operations further comprise:
detecting the landmark positions on the first image and conveying the landmark positions of the first image to the second image, wherein the landmark positions are associated with a plurality of points on the first and second images, wherein the first and second images include first and second facial images, and wherein the plurality of points include one or more of corner of eyes, corners or middle of lips, tip of a nose, and middle of earlobes, wherein the landmark positions are assigned to the first image; and
verifying the landmark positions conveyed to the second image after the first image at the initial location is rotated into the second image at the current location and rotated back to a near-first image at a near-initial location based on the rotation angle.

44. The machine-readable medium of claim 42, wherein the one or more operations further comprise:
capturing, via an image capturing device, the first and second images of a user, wherein the image capturing device includes a camera;
facilitating communication of the first and second images from the image capturing device to a display device; and
displaying, via the display device, the first image at a first point in time, and the second image at a second point in time.

45. The machine-readable medium of claim 42, wherein the first image and the second image are detected from the first frame and the second frame, respectively, wherein the first and second frames are detected from a video stream of a video captured via the image capturing device.

46. The machine-readable medium of claim 42, wherein the first parameter line comprises an immovable parameter line running in a first direction across the second image, wherein the first parameter line being anchored in one of the landmark positions associated with the first and second images, wherein the first parameter line remains running in the first direction when the first image rotates to the second image, wherein the first direction includes at least one of a horizontal direction, a vertical direction, a diagonal direction.

47. The machine-readable medium of claim 42, wherein the second parameter line comprises a movable parameter line running in a second direction across the second image, wherein the second parameter line being anchored in at least two of the landmark positions associated with the first and second images, wherein the second parameter line remains anchored in and moves corresponding to the at least two of the landmark positions as the first image rotates to the second image.

48. The machine-readable medium of claim 42, wherein the rotation angle represents a rotational gap between the first parameter line and the second parameter line, wherein the rotational gap is generated when the first image associated with the initial location turns in-plane into the second image associated with the current location, wherein the initial location includes an up-right position, the current location incudes a tilted position, and the near-initial location includes a near up-right position.

49. The machine-readable medium of claim 42, wherein the first image turns into the second image in response to a user movement associated with the user or an apparatus movement associated with the apparatus as facilitated by the user.
